(19) United States
(12) Patent Application Publication
(10) Pub. No.: US 2009/0284121 A1
(43) Pub. Date: Nov. 19, 2009

(54) CATHODE WITH A SURFACE EMITTER COMPOSED OF ELECTRICALLY CONDUCTIVE CERAMIC

(76) Inventor: Eberhard Lenz, Erlangen (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/427,872

(22) Filed: Apr. 22, 2009

(30) Foreign Application Priority Data
Apr. 22, 2008 (DE) 10 2008 020 164.2

(51) Int. Cl. H01J 1/14

(52) U.S. Cl. 313/310

(57) ABSTRACT

A cathode has a cathode body with a surface emitter composed of an electrically conductive ceramic material. The cathode has a high electron emission and a long lifespan.

### BACKGROUND OF THE INVENTION

1. Field of the Invention

The present invention concerns a cathode with a surface emitter.

2. Description of the Prior Art

A cathode with a surface emitter described in each of DE 27 27 907 C2 and DE 199 14 739 C1, for example.

The cathode known from DE 27 27 907 C2 has a rectangular surface emitter that consists of tungsten (W), tantalum (Ta) or rhenium (Re), for example, and has a layer thickness of 0.05 mm to 0.1 mm. The surface emitter (produced in a rolling process) has incisions that are arranged in alternation from two opposite sides transverse to the longitudinal direction. In operation of an x-ray tube containing the cathode, heating voltage is applied to the surface emitter of the cathode causing a current from 5 A to 15 A to flow so that electrons are emitted that are accelerated in the direction of an anode. X-ray radiation is generated in the surface of the anode when the electrons strike the anode.

Specific configurations of the temperature distribution can be achieved by the shape, length and arrangement of lateral incisions in the surface emitter according to DE 27 27 907 C2, since the heating of a body heated by current passage therethrough depends on the distribution of the electrical resistance across the current paths. Less heat is generated at points at which the electrically active planar cross-section of the surface emitter is greater than at points with a smaller cross-section (points with a greater electrical resistance).

The cathode disclosed in DE 199 14 739 C1 has a surface emitter formed of rolled tungsten plate and has a circular footprint (base). The surface emitter is sub-divided into conductor traces running in spirals that are spaced apart from one another by serpentine incisions.

An increase of the performance (capacity) in known cathodes is achieved by the surface emitter particularly quickly achieving its electron emission temperature by the use of so-called “push” currents. However, the material of the surface emitter reaches its load limit due to these high heating currents. Given a long and high thermal load, tears that run transversal to the weakest production direction of the surface emitter can form in the surface emitter due to a non-uniform texture produced by the rolling during manufacturing. The use of rolled tungsten plates therefore represents an intrinsic weak point that can negatively affect the lifespan of the cathode.

The use of WRe26 (tungsten alloy with 26% rhenium) as a material for the surface emitter is unsuitable due to the low creep resistance of WRe26. The term “creep”, means the plastic deformation of a material under constant mechanical stress and increased temperature. Due to a severe plastic deformation of the material that results from this, a low creep resistance is equivalent with a short lifespan of the surface emitter.

### SUMMARY OF THE INVENTION

An object of the present invention is to provide a cathode with a high electron emission and long lifespan.

The above object is achieved by a cathode according to the invention that has a cathode body with a surface emitter composed of an electrically conductive ceramic material.

By producing the surface emitter from an electrically conductive ceramic material, a substantially higher electron emission (i.e. a significant power increase) can be achieved while simultaneously ensuring a long lifespan.

In an embodiment of the cathode according to the invention, the electrically conductive ceramic material is titanium diboride (TiB₂).

In another embodiment, the electrically conductive ceramic material can be silicone carbide, coated with a material having a low electron work function.

### DESCRIPTION OF THE PREFERRED EMBODIMENTS

The cathode constructed in accordance with the present invention has a cathode body with a surface emitter composed of an electrically conductive material.

In one embodiment of the cathode, the electrically conductive ceramic material is titanium diboride (TiB₂).

If the surface emitter is composed of titanium diboride, it can be formed exclusively from titanium diboride.

Titanium diboride exhibits a number of advantages. Titanium diboride has a melting point of 3,220° C. and therefore is in the same range as tungsten (3,410° C.). Due to the ceramic character of TiB₂, a substantially improved creep and strength behavior is achieved together with the very high melting point. The specific electrical resistance of titanium diboride (ρ=16 μΩ·cm) is only slightly higher than that of tungsten (ρ=5.6 μΩ·cm). Moreover, the electron work function (φ) is approximately 0.5 eV less than that of tungsten, which amounts to approximately 4.9 eV. A surface emitter made from titanium diboride therefore emits distinctly more electrons at the same temperature than tungsten. Additionally, TiB₂ can be soldered in a simple manner.

In another embodiment, silicon carbide (SiC) can be used as an electrically conductive ceramic material, on which a coating material with a low electron work function—for example lanthanum oxide (La₂O₃), yttrium oxide (Y₂O₃) or thorium oxide (ThO₂)—is applied.

The preferred wall thickness for the electrically conductive ceramic material (if used) is approximately 80 μm to approximately 150 μm. The layer thickness of the coating material is advantageously between approximately 80 nm and 3 μm.

A surface emitter suitable for the cathode according to the invention is produced by sintering. For this purpose, a green compact (green part) is initially shaped from the material particles compacted in a prior production step, such that this green compact has the shape of a thimble. This processing is possible in a simple manner since the final hardness only arises through the following actual sintering process. The green compact is shaped such that the surface emitter to be produced is completely geometrically integrated into the ceramic material, with the sinter contraction being taken into account. After the subsequent sintering, the surface emitter is excised from the sintered green compact by means of electroerosion (spark erosion) so that the current feed legs of the surface emitter remain. The incisions (which are arranged in alternation from two opposite sides and transversal to the longitudinal direction, for example, or that have a serpentine structure) are generated by laser vaporization.

Finally, a contact piece made from tungsten is soldered to each end of the current feed legs of the surface emitter so that the electrical connection to the current feed lines can be produced as is conventional from a solid solution-hardened and particle-reinforced molybdenum base alloy.

Although modifications and changes may be suggested by those skilled in the art, it is the intention of the inventor to embody within the patent warranted hereon all changes and modifications as reasonably and properly come within the scope of his contribution to the art.

I claim as my invention:

1. A thermionic cathode comprising:
a cathode body comprising a surface emitter that, when heated, emits electrons therefrom; and
said surface emitter being comprised of an electrically conductive ceramic material.

2. A thermionic cathode as claimed in claim 1 wherein said electrically conductive ceramic material is titanium diboride.

3. A thermionic cathode as claimed in claim 1 wherein said surface emitter consists of titanium diboride.

4. A thermionic cathode as claimed in claim 1 wherein said electrically conductive ceramic material is silicon carbide and wherein said surface emitter further comprises a coating on said ceramic material, said coating being comprised of a coating material having a low electron work function.

5. A thermionic cathode as claimed in claim 4 wherein said coating material is lanthanum oxide.

6. A thermionic cathode as claimed in claim 4 wherein said coating material is yttrium oxide.

7. A thermionic cathode as claimed in claim 4 wherein said electrically conductive ceramic material has a thickness of at least 50 μm.

8. A thermionic cathode as claimed in claim 7 wherein said coating material has a layer thickness of at least 80 nm.

9. A thermionic cathode as claimed in claim 1 wherein said electrically conductive ceramic material has a thickness of at least 50 μm.
